(19) United States
(12) Patent Application Publication
(10) Pub. No.: US 2024/0417529 A1
(43) Pub. Date: Dec. 19, 2024

(54) RUBBER COMPOSITION CONTAINING RECYCLED CARBON BLACK FOR TIRES

(71) Applicants: Chaitra Mahesha TRIF, Greenville, CA (US); COMPAGNIE GENERALE DES ETABLISSEMENTS MICHELIN, Clermont-Ferrand (FR)

(72) Inventor: Chaitra Mahesha TRIF, Greenville, SC (US)

(21) Appl. No.: 18/705,052

(22) PCT Filed: Oct. 28, 2022
(86) PCT No.: PCT/US2022/078899

§ 371 Date: Apr. 26, 2024

(51) Int. Cl. C08K 3/04; B60C 1/00; C08K 3/36; C08K 5/00

(52) U.S. Cl. CPC C08K 3/04; B60C 1/0016; C08K 3/36; C08K 5/0025; C08K 2201/006

(57) ABSTRACT

A more environmentally friendly silica reinforced rubber composition comprising non-surface treated recovered carbon black. The rubber composition is particularly useful as tread rubber and having performance characteristics similar or improved to that of rubber compositions comprising conventional first-use carbon black produced using fossil fuel feedstock. The ability to get good cured rubber composition performance using non-surface treated recovered carbon black facilitates the use of recovered carbon black for tire manufacturing.

### FIELD OF THE INVENTION

The subject matter of the present invention relates to rubber compounds for tires comprising a recovered or pyrolysis carbon black (“rCB”). More particularly, this invention relates to a more environmentally friendly rubber composition comprising non-surface treated rCB, the rubber composition particularly useful as tread rubber and having performance characteristics similar or improved to that of rubber compositions comprising conventional carbon black (“CB”) produced using fossil fuel feedstock.

### BACKGROUND OF THE INVENTION

Carbon black is a well-known filler used in elastomer compositions. Carbon black improves the rubber composition's properties, such as reducing wear and improving strength of the rubber composition and as an enhancer of certain properties, it is deemed a “reinforcing” filler.

Carbon black is produced from incomplete combustion of a hydrocarbon containing substance. In a general sense, it is the soot, or dark component of smoke and is usually produced by first producing an intensely hot combustion zone with a convenient fuel, then a fossil fuel feedstock, in excess of stoichiometric quantities is injected into that intensely hot zone. With this injection, carbon black will be produced, and various grades are obtained by adjusting the parameters and feed stock used to obtain the desired result. The carbon black may be made a continuous process producing furnace grades or in a cyclical process to produce thermal grades of carbon black. The carbon particles thus produced are separated from the process gas stream or “smoke” by conventional means and pelletized to increase the bulk density. Carbon black obtained in such a fashion is referred to herein as “virgin carbon black.”

Since the virgin carbon black is produced with a fossil fuel feedstock, the process and product contribute to CO2 production and is considered a non-renewable component used in the production of tires. The use of carbon black from alternative more environmentally friendly sources is desirable, such as recycled carbon black.

Recycled carbon black, herein referred to as recovered carbon black or “CB” is obtained during the process of recycling end-of-life pneumatic tires. The end-of-life pneumatic tires is subjected to a pyrolysis process which produces rCB. It is known in the industry that rCB is devoid of functional groups upon the surface of the carbon black (A comparison of surface morphology and chemistry of pyrolytic carbon blacks with commercial carbon blacks, Powder Technology 160 (2005) 190-193). It is also recognized that use of non-functionalized rCB as a replacement in conventional rubber mixes produces a rubber composition that presents many problems. In fact, it has been found that recovered carbon black from pyrolysis, for the same surface area, has a reinforcing strength that is lower than that of virgin carbon black.

Others have found solutions to the inadequacy of rCB by functionalizing the rCB such as shown in patent application publication EP 3173251 with a hydroxyl and/or carboxyl groups, or shown in patent application publication US 2020/0189318 with the use of thiol or disulfide groups. Functionalization of the rCB, however requires an extra step in the use of rCB resulting in additional expense and environmental impact.

What is needed is a more environmentally friendly rubber composition than rubber compositions using virgin carbon black (also referred to as “virgin” carbon black or “industrial” carbon black) and method of making such a rubber formulation utilizing non-functionalized rCB having improved properties.

### SUMMARY OF THE INVENTION

Aspects and advantages of the invention will be set forth in part in the following description, or may be obvious from the description, or may be learned through practice of the invention.

In one exemplary embodiment a rubber composition is presented that includes a dienic rubber elastomer, 35 to 70 phr of reinforcing filler comprising 50% or more of silica by weight of the total reinforcing filler, and the remaining filler comprised of non-surface treated recovered carbon black, a silane coupling agent and a vulcanizing system.

In another exemplary embodiment, a rubber composition is presented that includes a dienic rubber elastomer consisting of natural rubber, polybutadiene, styrene-butadiene rubber or combinations of two or more thereof, 35 to 70 phr of reinforcing filler comprising 50% or more of silica by weight of the total reinforcing filler, and the remaining filler comprised of non-surface treated recovered carbon black, a silane coupling agent and a vulcanizing system.

In another exemplary embodiment, a rubber composition is presented that includes a dienic rubber elastomer consisting of 100 phr natural rubber, 35 to 70 phr of reinforcing filler comprising 50% or more of silica, and the remaining filler comprised of non-surface treated recovered carbon black, a silane coupling agent and a vulcanizing system.

In another exemplary embodiment, a rubber composition is presented that includes a dienic rubber elastomer consisting of 60-90% natural rubber and/or isoprene rubber, 0-40% styrene-butadiene rubber and 0-40% polybutadiene rubber, 35 to 70 phr of reinforcing filler comprising 50% or more of silica, and the remaining filler comprised of non-surface treated recovered carbon black, a silane coupling agent and a vulcanizing system.

In another exemplary embodiment, a rubber composition is presented that includes a dienic rubber elastomer consisting of 30-60% natural rubber and/or isoprene rubber with the remaining rubber elastomer being a combination of two styrene-butadiene rubbers or a styrene-butadiene rubber and a polybutadiene rubber, 35 to 70 phr of reinforcing filler comprising 50% or more of silica, and the remaining filler comprised of non-surface treated recovered carbon black, a silane coupling agent and a vulcanizing system.

In another exemplary embodiment, a rubber composition is presented that includes a dienic rubber elastomer consisting 60% natural rubber, 20% polybutadiene and 20% styrene-butadiene rubber, 35 to 70 phr of reinforcing filler comprising 50% or more of silica, and the remaining filler comprised of non-surface treated recovered carbon black a silane coupling agent and a vulcanizing system.

In yet another exemplary embodiment a rubber composition is presented that includes a dienic rubber elastomer, 40 to 65 phr of reinforcing filler comprising 50% or more of silica by weight of the total reinforcing filler, and the remaining filler comprised of non-surface treated recovered carbon black, a silane coupling agent and a vulcanizing system.

In yet another exemplary embodiment a rubber composition is presented that includes a dienic rubber elastomer, 50 to 60 phr of reinforcing filler comprising 50% or more of silica by weight of the total reinforcing filler, and the remaining filler comprised of non-surface treated recovered carbon black, a silane coupling agent and a vulcanizing system.

In yet another exemplary embodiment, a rubber composition is presented that includes a dienic rubber elastomer consisting of 20-60% natural rubber or isoprene rubber with the remaining rubber elastomer being a combination two styrene-butadiene rubbers or a styrene-butadiene rubber and a polybutadiene rubber, 50 to 70 phr of reinforcing filler comprising 50% or more of silica, and the remaining filler comprised of non-surface treated recovered carbon black, a silane coupling agent and a vulcanizing system.

In yet another exemplary embodiment a rubber composition as described in one of the embodiments above also including, an antioxidation agent and a wax.

In yet another exemplary embodiment a rubber composition as described in one of the embodiments above also including, a plasticizer and/or an oil.

In yet another exemplary embodiment a rubber composition as described in one of the exemplary embodiments disclosed above, the reinforcing filler is comprised of 60% or more silica.

In another exemplary embodiment a rubber composition as described in one of the exemplary embodiments disclosed above, the reinforcing filler is comprised of 70% or more silica.

In another exemplary embodiment a rubber composition as described in one of the exemplary embodiments disclosed above, the reinforcing filler is comprised of no greater than 95% silica.

In another exemplary embodiment a rubber composition as described in one of the exemplary embodiments disclosed above, the vulcanizing system comprises of sulfur and at least one accelerator such as families of sulfenamides, thiurams or guanidines.

These and other features, aspects and advantages of the present invention will become better understood with reference to the following description and appended claims.

### DETAILED DESCRIPTION OF THE INVENTION

The present invention provides a more environmentally friendly rubber composition than rubber compositions using virgin carbon black and method of making such a rubber formulation utilizing non-functionalized rCB having similar or improved properties. Tire composition formulations are the result of mixing various components together at specific proportions and sequence and reacting them under controlled temperature conditions. As rubber compositions are highly dependent upon the chemical reactions that occur during and after mixing and processing, the end result of an experimental mixture can be unpredictable due to rubber formulation's relationship to the chemical arts which are well established to be a member of the unpredictable arts. This invention is the result of a surprising discovery resulting in a more environmentally friendly rubber composition for a tread with equivalent or improved wear/fuel consumption compromise by incorporating recovered carbon black in place of a CB produced using fossil fuel feedstock.

The invention specifically pertains to the use of rCB use in tire tread. The available patent literature shows a negative impact on energy dissipation, and hence rolling resistance, and rigidity, which affects wear performance, when rCB is used. The invention provides for a rubber composition where silica comprises the majority of the filler and the remaining filler is comprised of pyrolysis carbon black. It should be understood that when referred to a composition as “only containing” rCB as the “only” carbon black, a de minimus amount of virgin carbon black may be present and still be within the scope of the claimed invention.

The invention includes a dienic elastomer system and specifically contemplates the use in any dienic elastomer system suitable for tire tread applications. Suitable diene rubbers as the optional rubber component for particular embodiments of the present invention include highly unsaturated diene rubbers such as, for example, polybutadienes (BR), synthetic polyisoprenes (IR), natural rubber (NR), butadiene copolymers, isoprene copolymers and mixtures of two or more of these rubbers. Such copolymers include, for example, butadiene/styrene copolymers (SBR), isoprene/butadiene copolymers (BIR), isoprene/styrene copolymers (SIR) and isoprene/butadiene/styrene copolymers (SBIR).

The reinforcing filler system includes a majority (>50% by total weight of reinforcing filler) of silica and the remaining amount rCB (<50% by total weight of reinforcing filler). In at least one embodiment the filler system comprises 4-45% rCB with a total filler loading range between 35 to 70 phr (parts per hundred rubber by weight). In the first example, F1, used below silica made up 80% of the filler loading of the mix, while in the second example, F2, the silica made up approximately 70% of the filler loading mix. It is expected that good results would be had with mixes having silica represent 50% or more of the filler compositions, 60% or more, 70% or more up to a maximum of 95% silica as the reinforcing filler.

The rCB used has a surface area and structure that is outside the typical range of “reinforcing” carbon blacks used in tread compositions. The rCB used also contains contaminants, or “ash” not found in virgin carbon black. The non-typical surface area and presence of contaminants would be expected to negatively affect a composition containing rCB as a reinforcing filler, but surprisingly, in the case of the formulation in accordance to the claimed invention, the wear performance of the rubber composition was not negatively affected.

For purposes of describing the invention, reference now will be made in detail to embodiments and/or methods of the invention, one or more examples of which are illustrated herein. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

The following terms are defined as follows for this disclosure:

The BET surface area of carbon black is determined by the ASTM Standard D6556 for determining the total and external surface area by nitrogen adsorption.

The maximum tan delta and complex shear modulus G* dynamic properties for the rubber compositions were measured at 60° C. on a Metravib Model VA400 ViscoAnalyzer Test System in accordance with ASTM D5992-96. The response of a sample of vulcanized material (double shear geometry with each of the two 10 mm diameter cylindrical samples being 2 mm thick) was recorded as it was being subjected to an alternating single sinusoidal shearing stress at a frequency of 10 Hz under a controlled temperature of 60° C. Scanning was effected at an amplitude of deformation of 0.1 to 100% peak to peak. The maximum value of the tangent of the loss angle tan delta (max tan 8) was determined during the outward cycle. The complex shear modulus G* was determined at 50% strain peak-to-peak during the outward cycle.

The tear resistance is measured at 100° C. The breaking load (FRD) is in N/mm of thickness and the elongation at break (ARD) in percentage are measured on a test piece of dimensions 10×142×2.5 mm notched with 3 notches that each have a depth of 3 mm. The tear resistance index (TR) was then provided as: TR=(FRD*ARD)/100.

Abrasion Performance Index was measured on an abrasion device on which a rubber sample piece was contacted with a spinning abrasive disk for a sliding length of 50 meters. The weight of the rubber sample piece was weighed before the test and after the test. The greater the mass loss during the test, the less effective is the rubber for wear performance. The Index for an inventive formulation was calculated by dividing the mass loss of the witness formulation by the mass loss of the inventive formulation and multiplying the result by 100. The higher the Index, the less mass loss compared to the witness formulation.

### EXAMPLES

Two inventive compounds (F1, F2 and F3) and a comparison compound (W1 and W2) were prepared as shown in Table 1. The compounds have a composition that is typical of a tread portion of a pneumatic tire. It should be understood that the invention is not limited to these compositions or for a particular location within the tire.

For all inventive examples, rCB represented the only carbon black used. The rCB used was P550 having a BET of 66.4 m²/g and ash at 825° C. equal to 18.26 percent available commercially from Scandinavian Enviro Systems. This type of rCB is listed here as exemplary and not limiting. It should be understood that de minimus amounts of carbon black may be present and not be outside the scope of the invention.

No surface treatment of the rCB has been performed. Such a treatment would require an additional step or steps to the process and involve other materials that would add to the cost and environmental impact of the use of rCB. Utilizing the claimed invention allows the use of untreated rCB, making its use easier to integrate into products and therefore accelerating a positive environmental impact.

TABLE 1
The compositions in phr of two inventive embodiments
and a comparative compound, all values in parts per
hundred of rubber by weight (“phr”).

| | F1 | F2 | W1 | F3 | W2 |
|---|---|---|---|---|---|
| NR | 100 | 100 | 100 | 60 | 60 |
| SBR | | | | 20 | 20 |
| BR | | | | 20 | 20 |
| N347 | | | 10 | | |
| N234 | | | | | 3 |
| P550 (rCB) | 10 | 15 | | 3 | |
| Silica | 40.9 | 40.9 | 40.9 | 51.3 | 51.3 |
| 6PPD | 1.5 | 1.5 | 1.5 | 2.5 | 2.5 |
| PARAFFIN | 1 | 1 | 1 | 1 | 1 |
| SI69 | 3.27 | 3.27 | 3.27 | 5.1 | 5.1 |
| DPG | 0.4 | 0.4 | 0.4 | 0.51 | 0.51 |
| SAD | 2 | 2 | 2 | 2.5 | 2.5 |
| ZnO | 3 | 3 | 3 | 1 | 1 |
| CBS | 1.5 | 1.5 | 1.5 | 1.1 | 1.1 |
| S | 2 | 2 | 2 | 1.1 | 1.1 |

NR is a natural rubber, SBR is styrene butadiene rubber and BR is polybutadiene rubber. In the particular embodiments shown here, the SBR is solution polymerized SBR.

The virgin carbon black N347 and N234 were used in the examples herein.

The rCB used was P550 from Scandinavian Enviro Systems Company. This rCB has an amount of ash equal to 18.5% by weight relative to the total weight of the Rcb, an amount of sulfur equal to 3% by weight relative to the total weight of the rCB, an amount of Zn equal to 4.5% by weight relative to the total weight of the rCB, an STSA specific surface area of 56 m2/g (ASTM D6556-2021) and a void volume measured at 50 MPa of 44 ml/100 g (ASTM D7854-21)).

The useful composition in the context of the invention comprises from 1 phr to 35 phr of recovered carbon black, more particularly in other embodiments 3 phr to 15 phr of recovered carbon black.

By “recovered carbon black” is meant within the meaning of the present invention a carbon black from a pyrolysis process of a material comprising at least one carbonaceous polymer and a carbon black, hereinafter “pyrolysis material” for example in the context of the recycling of such a material. The physical state in which the pyrolysis material is presented is irrelevant, whether in the form of powder, granule, strip, or any other form, cross-linked or non-crosslinked.

Preferably, the pyrolysis material can be recovered from manufactured items or products generated during their manufacture/production (such as by-products or offcuts); these manufactured items may be selected from the group consisting of pneumatic tires, non-pneumatic tires, industrial conveyor belts, transmission belts, rubber seals, rubber hoses, shoe soles and windshield wipers. More preferably, the recovered carbon black used in the context of the present invention is a carbon black obtained from a pyrolysis process whose material to be pyrolyzed is derived from manufactured items selected from the group consisting of pneumatic tires and non-pneumatic tires.

Pyrolysis of recovered carbon black in the context of the present invention means any type of thermal decomposition in the absence of oxygen and whose raw material is the material to be pyrolyzed as defined above. Recovered carbon blacks are therefore distinguished from so-called industrial carbon blacks and/or ASTM grade, both also referred to as “virgin carbon black” in that the carbonaceous raw material used for pyrolysis is a material comprising at least one carbonaceous polymer and one carbon black and not materials from oil cuts or coal or oils of natural origin.

The recovered carbon blacks used in the context of the present invention differ from known carbon blacks such as virgin carbon blacks, in particular carbon blacks called “furnace” carbon black, as recovered carbon blacks generally possess a higher ash content.

The recovered carbon black used in the context of the present invention has an ash content in a range ranging from 5 to 30% by weight, more typically from 8 to 25% by weight, most usually from 10% to 22% by weight, relative to the total weight of recovered carbon black.

The recovered carbon black used in the context of the present invention has a sulfur content greater than 2% by weight, lower percentage sulfur content is preferred, for example generally 2 to 5% by weight, relative to the total weight of recovered carbon black.

Typically the recovered carbon black used in the context of the present invention has a zinc content greater than or equal to 2% by weight, and more specifically in the range of 2.5 to 8% by weight, relative to the total weight of recovered carbon black.

Preferably, the recovered carbon black used in the context of the present invention has a specific surface area STSA measured according to ASTM D 6556-2021 in a range ranging from 20 to 200 m2/g, more preferably ranging from 30 to 90 m2/g.

Preferably, the recovered carbon black used in the context of the present invention has an void volume measured according to ASTM D7854-21 (date or version) and at a pressure of 50 MPa in a range ranging from 30 to 60 ml/100 g, more preferably ranging from 35 to 55 ml/100 g.

The ash content is determined by calcination in platinum capsules in a muffle furnace at 825° C. according to the following protocol. One capsule is previously identified before each measurement series and is set to the nearest 0.1 mg and the mass is denoted P0. In the capsule, 5 g of recovered carbon black sample is introduced which is weighed precisely to the nearest 0.1 mg; this mass is denoted P1. The crucible and its contents are pre-calcined using a Bunsen burner until fumes appear and ignition of the product. Once the product has completely combusted, the crucible and its contents are introduced into a muffle oven heated to 825° C. for 1 h. After 1 hour, the crucible is removed from the oven and immediately introduced into a moisture analyzer at room temperature. When the crucible and ash have returned to room temperature, the crucible is weighed again to obtain the P2 mass. Finally, it is possible to obtain the ash content (% ash) using the formula below:

$$\% ash = ( P 2 - P 0 ) / ( P 1 - P 0 ) \times 100 \qquad ( 1 )$$

The zinc content in the recovered carbon black is carried out after calcination of the sample, then recovery of the ash in an acidic medium and determination by ICP-AES (inductively coupled plasma atomic emission spectroscopy). The ash is obtained by carrying out the above protocol Approximately 100 mg of ash (test portion) is taken and introduced into a PFA (perfluoroalkoxy) tube for HotBlock hot plate. Then added 8 mL of 37% concentrated hydrochloric acid, 3 mL of 65% concentrated nitric acid and 0.5 mL of 40% hydrofluoric acid. Close the tube with its cap and heat to 130° C. for 2 hours. After cooling, the contents are then transferred with ultrapure water to a 100 ml PTFE (polytetrafluoroethylene) volumetric flask already containing 2 g of boric acid (to neutralize hydrofluoric acid). It is completed with ultrapure water up to the gauge. The solution obtained is diluted by 100, taking 1 mL from a 100 mL vial of PFTE, previously containing 8 mL of 37% concentrated hydrochloric acid, 3 mL of 65% concentrated nitric acid, 0.5 mL of 40% hydrofluoric acid and 2 g of boric acid. This dilute solution is then filtered on a 0.45 μm GHP syringe filter before being analyzed by atomic emission spectrometry—inductively coupled plasma (ICP-AES). Prior to the analysis of the dilute solution, at least 5 standards are analyzed by ICP-AES at zinc concentrations of 0, 0.5, 1, 2 and 5 mg/L. These standards were prepared in 100 mL volumetric flasks by diluting a certified commercial solution to a zinc concentration of 1 g/L.

These volumetric vials previously contain 8 mL of 37% concentrated hydrochloric acid, 3 mL of 65% concentrated nitric acid, 0.5 mL of 40% hydrofluoric acid and 2 g of boric acid. Standard solutions are analyzed by ICP-AES at a wavelength of λZn=202.613 nm. For each standard concentration (c), the signal strength of zinc IZn is plotted on a graph IZn=f(c), which corresponds to the calibration line (type y=ax+b). The sample solution (dilute solution) of unknown concentration is then measured under the same conditions as the standards. The measured intensity is related to the concentration thanks to the calibration line obtained previously. The concentration [c]ash in % by mass is thus obtained directly by the software, because the test portion and the volume have been previously recorded. The concentration of zinc in recovered black [c]black in % by weight is obtained by the following equation:

$$[ c ] black = [ c ] ash ⋆ 100 ⋆ \% ash \qquad ( 2 )$$

The determination of the sulphur content in recovered carbon blacks is carried out by LECO furnace. LECO sulphur analysers are designed to measure, inter alia, the sulphur content in organic and/or inorganic materials by combustion and non-dispersive infrared detection. Before measuring the sulphur content on the sample, the crucible are cleaned and the furnace calibrated. The LECO oven crucibles are cleaned beforehand: the empty crucible must be analysed, under the same conditions as the samples. The preparation of the calibration curve is done from a commercial standard called “BBOT” whose purity is greater than 99.99% and whose content of carbon (C), hydrogen (H), nitrogen (N), oxygen (O) and sulfur (S) is guaranteed. This grade is C %: 72.52; H % 6.09; N % 6.51; 0% 7.43 and S % 7.44. Approximately 10±3, 20±3 and 40±3 mg of BBOT are weighed in a basket. The standard/crucible assembly is fed into the combustion furnace, regulated at 1350° C. under pure oxygen. The combination of furnace temperature and analysis rate causes the sample to burn and release sulphur and/or carbon as SO2 (g). After a time of 20 s, oxygen begins to circulate through the “lance” to accelerate the combustion of hard-to-burn materials. Sulfur and/or carbon, in the form of SO2 (g), are carried by a flow of oxygen through the sensing infrared cells. The instrument software plots a line connecting the introduced standard mass and the observed response (area) on the detector. This results in a calibration line. After thoroughly cleaning the sampling material, approximately 80±5 mg of recovered carbon black is weighed and fed into a LECO oven crucible. The area of the observed SO2 peak is related to the concentration thanks to the calibration line. The instrument software then calculates the mass of sulphur in the sample sample through the sample mass.

Recovered carbon blacks are marketed for example by the company BlackBear under the reference BBCT30, P550 by the company Enviro™, BolderBlack by Bolder Industries.

TABLE 2
Ash Content Analysis of P550 Recovered Carbon Black

| | description | P550 |
|---|---|---|
| ash (%) | 5 to 30% | 18.5 |
| S-content | >2% (between 2.5 and 5) | 3% |
| Zn content | >2% (between 2.5 and 8) | 4.50% |
| STSA | 20 to 200 | 56 |
| empty volume 50 Mpa | 30 to 60 ml/100 g | 44 |

The silica (SiO2) that may be used are known to a person skilled in the art to be those that are suitable in particular as reinforcing inorganic fillers. The silica used may be, in particular, any precipitated or pyrogenic silica. The silica may be a highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, for example.

Silane coupling agents are well known and are sulfur-containing organosilicon compounds that react with the silanol groups of the silica during mixing and with the elastomers during vulcanization to provide improved properties of the cured rubber composition. Any of the organosilicon compounds that contain sulfur and are known to one having ordinary skill in the art are useful for practicing embodiments of the present invention. Examples of suitable silane coupling agents having two atoms of silicon in the silane molecule include 3,3′-bis(triethoxysilylpropyl) disulfide and 3,3′-bis(triethoxy-silylpropyl) tetrasulfide (known as Si69). Both of these are available commercially from Evonik as X75-S and X50-S respectively, though not in pure form. Evonik reports the molecular weight of the X50-S to be 532 g/mole and the X75-S to be 486 g/mole. Both of these commercially available products include the active component mixed 50-50 by weight with a N330 carbon black.

Other examples of suitable silane coupling agents having two atoms of silicon in the silane molecule include 2,2′-bis(triethoxysilylethyl)tetrasulfide, 3,3′-bis(tri-t-butoxy-silylpropyl) disulfide and 3,3′-bis(di t-butylmethoxysilylpropyl) tetrasulfide. Examples of silane coupling agents having just one silicon atom in the silane molecule include, for example, 3,3′ (triethoxysilylpropyl) disulfide and 3,3′ (triethoxy-silylpropyl) tetrasulfide. The amount of silane coupling agent can vary over a suitable range as known to one having ordinary skill in the art. Typically the amount added is between 7 wt. % and 15 wt. % or alternatively between 8 wt. % and 12 wt. % or between 9 wt. % and 11 wt. % of the total weight of silica added to the rubber composition.

The rubber components shown in table 1, except the sulfur and non-DPG accelerator, were mixed in a Banbury mixer until a temperature of between 150° C. and 170° C. was reached. The sulfur and accelerator was added during the second phase on a mill. The rubber formulations were cured at between 140° C. and 150° C. The formulations were then tested to measure their properties, the results of which are shown in tables herein.

Test results show comparable dynamic properties between the inventive compositions (F1, F2) and the comparative witness (W1). The shear modulus of the inventive compositions was similar to that of the witness, with the shear modulus being slightly lower in the sample having 10 phr of rCB compared to the comparative having 10 phr of virgin carbon black. Increasing the rCB to 15 phr increased the shear modulus to a value slightly higher than that of the comparative, while also increasing the Max Tan Delta to a value close to that of the comparative (97 index compared to 100) as shown in Table 3.

Abrasion test results showed similar results between the inventive compositions (F1 and F2) and identical abrasion results between the inventive composition having a 15 phr rCB compared to the comparative witness composition (W1). Table 3 shows the abrasion test results, Max Tan Delta and Shear Modulus G* indexed to the value of the witness composition.

TABLE 3
Normalized test results indexed to the comparative W1.

| | F1 | F2 | W1 | F3 | W2 |
|---|---|---|---|---|---|
| Mass loss index (DIN abrasion) | 96 | 100 | 100 | No data | No data |
| Max Tan Delta, Indexed | 89 | 97 | 100 | 100 | 100 |
| Shear Modulus G*50%, Index | 94 | 106 | 100 | 100 | 100 |

The tear resistance of the samples were measured at 100° C. It was found that the tear resistance was maintained or improved with the inventive composition.

TABLE 4
Tear resistance test results of the compositions.

| | F1 | F2 | W1 | F3 | W2 |
|---|---|---|---|---|---|
| Tear resistance, Indexed | 106 | 100 | 100 | 119 | 100 |
| Tensile Stress, Indexed | 98 | 94 | 100 | 105 | 100 |
| Tensile strain, Indexed | 101 | 93 | 100 | 114 | 100 |

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

As used herein, the term “method” or “process” refers to one or more steps that may be performed in other ordering than shown without departing from the scope of the presently disclosed invention. As used herein, the term “method” or “process” may include one or more steps performed at least by one electronic or computer-based apparatus. Any sequence of steps is exemplary and is not intended to limit methods described herein to any particular sequence, nor is it intended to preclude adding steps, omitting steps, repeating steps, or performing steps simultaneously. As used herein, the term “method” or “process” may include one or more steps performed at least by one electronic or computer-based apparatus having a processor for executing instructions that carry out the steps.

The terms “a,” “an,” and the singular forms of words shall be taken to include the plural form of the same words, such that the terms mean that one or more of something is provided. The terms “at least one” and “one or more” are used interchangeably. Ranges that are described as being “between a and b” are inclusive of the values for “a” and “b.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

What is claimed is:

1. A rubber composition comprising:
a dienic rubber elastomer;
35 to 70 phr of reinforcing filler comprising 50% or more of silica and the remaining filler comprised of non-surface treated recovered carbon black;
a silane coupling agent; and
a vulcanizing system.

2. The rubber composition of claim 1 wherein the dienic rubber elastomer is natural rubber.

3. The rubber composition of claim 1 wherein the dienic rubber elastomer consists of natural rubber, polybutadiene, styrene-polybutadiene or combinations of two or more thereof.

4. The rubber composition of any one of the above claims wherein the recovered carbon black has a BET surface area of 66 m²/g or greater.

5. The rubber composition according to any preceding claim, wherein the recovered carbon black has an ash content ranging from 8 to 25% by weight, relative to the total weight of recovered carbon black.

6. The rubber composition according to any one of the preceding claims, wherein the recovered carbon black has a sulfur content ranging from 2.5 to 5% by weight, relative to the total weight of recovered carbon black.

7. The rubber composition of any one of the above claims wherein the recovered carbon black has ash at 825° C. less than 20 percent.

8. The rubber composition of any one of the above claims wherein the dienic rubber elastomer is comprised of at least 20% of a polyisoprene rubber.

9. The rubber composition of any one of the above claims comprising 40 to 60 phr of reinforcing filler comprising 50% or more of silica and the remaining filler comprised of non-surface treated recovered carbon black.

10. The rubber composition of any one of the above claims wherein the reinforcing filler comprises 60% or more of silica and the remaining filler comprised of non-surface treated recovered carbon black.

11. The rubber composition of any one of the above claims wherein the reinforcing filler comprises at least 5% non-surface treated recovered carbon black.

12. The rubber composition of any one of the above claims wherein the reinforcing filler comprises at least 10% non-surface treated recovered carbon black.

13. The rubber composition of any one of the above claims wherein the reinforcing filler comprises 70% or more of silica and the remaining filler comprised of non-surface treated recovered carbon black.

14. The rubber composition of any one of the above claims wherein the mixing to form an intermediary composition further comprises a guanidine compound.

15. A tire tread comprising the rubber composition of any one of the above claims.
